(19) United States
(12) Patent Application Publication
(10) Pub. No.: US 2009/0137150 A1
(43) Pub. Date: May 28, 2009

(54) Terminal structure for coaxial cable

(76) Inventors: Chi-Neng Huang, Tainan City (TW); Chun-Hung Yeh, Tainan City (TW); Mao-Chang Chu, Rende Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/987,145

(22) Filed: Nov. 28, 2007

(51) Int. Cl. H01R 9/05

(52) U.S. Cl. 439/578

(57) ABSTRACT

A terminal structure for a coaxial cable includes a casing having a passage defined axially therethrough and a plurality of stops extend from an inner periphery of the passage. An axle has a connection end and a plurality of protrusions extend from an outer periphery of the connection end. The connection end of the axle is inserted into the passage and the protrusions are stopped by the stops. A non-conductive material is filled in a partition of the passage and connects the axle and the casing. The non-conductive material is filled in the partition of the passage by way of injection.

### FIELD OF THE INVENTION

The present invention relates to a terminal structure for a coaxial cable and includes an axle and a casing which is connected to the axle by non-conductive material which is filled in the space between the two parts by way of injection.

### BACKGROUND OF THE INVENTION

A conventional terminal for a coaxial cable is widely used for connecting electronic means and shown in FIG. 1. The conventional terminal for a coaxial cable generally includes a metal casing 10 with a metal axle 30 received in the casing 10, a sheath 20 is mounted to the axle 30 and located between the axle 30 and the casing 10. The assembly steps for assembling the conventional terminal of a coaxial cable is first to insert the axle 30 and the sheath 20 in the casing 10, to fill glue into the casing 10 via two respective holes 101, 201 in the casing 10 and the sheath 20, to fill the groove 301 in the axle 30 and two respective holes 101, 201 with the glue 40, to dry the glue 40, and to test the coaxial cable.

It requires different types of molds and machine to manufacture the casing 10, the sheath 20 and the axle 30, and the casing 10, the sheath 20 and the axle 30 are respectively machined to have the holes 101, 201 and the groove 301. It takes a lot of time to assemble the three parts 10, 20, 30 due to their small sizes, and it requires techniques to fill the glue 40 properly. If the glue 40 is filled too much, the glue 40 spreads out from the holes 101, 201, and this reduces the appearance. If the amount of glue 40 is not sufficient, the connection between the three parts 10, 20, 30 are not reliable and the terminal cannot pass the torque and pull tests. Besides, at least two days of drying to the glue 40 is needed before the terminal is tested, this increases the cost of management.

The present invention intends to provide a terminal structure for a coaxial cable and includes a casing and an axle, and non-conductive material is filled in space between the casing and axle by way of injection. The amount of non-conductive material can be precisely controlled and no drilling or machining process to the casing and the cable needed.

### SUMMARY OF THE INVENTION

The present invention relates to a terminal structure of a coaxial cable and comprises a casing having a flange extending radially outward from a first end thereof and a passage is defined axially through the casing. A plurality of stops extend from an inner periphery of the passage. An axle has a connection end and a plurality of protrusions extends from an outer periphery of the connection end. The connection end of the axle is inserted into the passage and the protrusions are stopped by the stops. A non-conductive material is filled in a partition of the passage and connects the axle and the casing.

The primary object of the present invention is to provide a terminal structure of a coaxial cable wherein the casing and the axle are connected by non-conductive material which is filled in the space between the axle and the casing by way of injection.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view of a conventional terminal of coaxial cable;

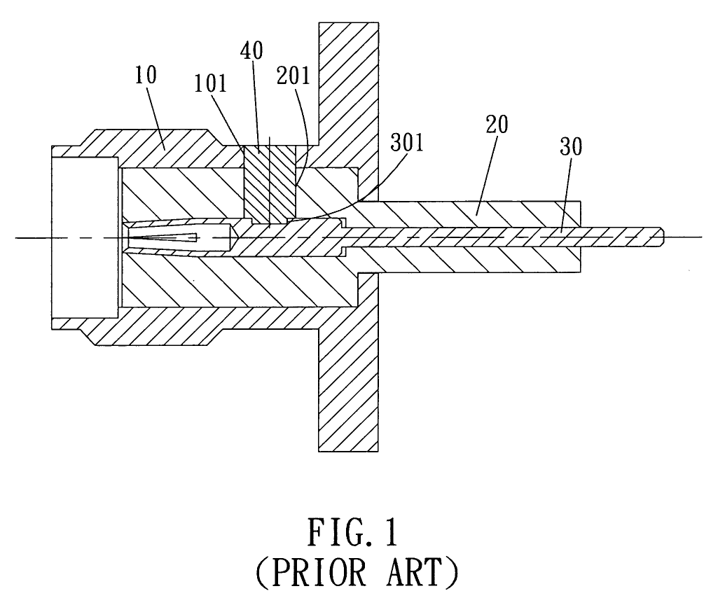

FIG. 2 is an exploded view to show the of the terminal for a coaxial cable of the present invention, and

FIG. 3 is a cross sectional view of the terminal for a coaxial cable of the present invention.

### DETAILED DESCRIPTION OF THE PREFERRED EMBODIMENT

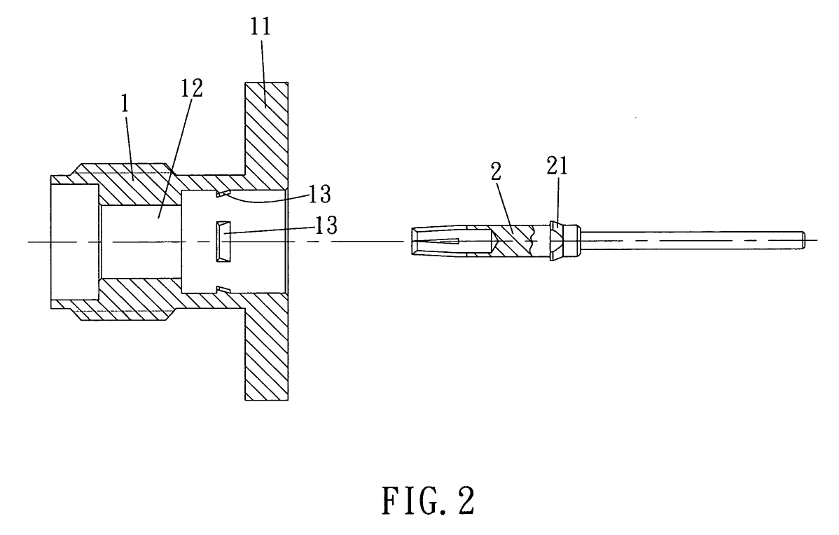

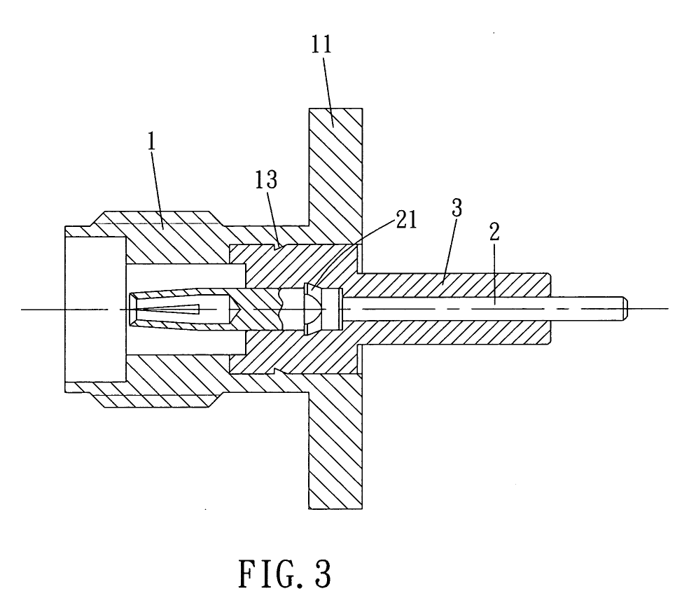

Referring to FIGS. 2 and 3, the terminal for a coaxial cable of the present invention comprises a metal casing 1 which has a flange 11 extending radially outward from a first end thereof and a passage 12 is defined axially through the casing 1. The passage 12 includes two enlarged partitions in the first end and the second end of the casing 1. A plurality of stops 13 extend from an inner periphery of the enlarged partition of the passage 12 in the first end of the casing 1. A metal axle 2 has a connection end and a plurality of protrusions 21 extend from an outer periphery of the connection end. The connection end of the axle 2 is inserted into the enlarged partition in the first end of the casing 1 and the protrusions 21 are stopped by the stops 13.

The casing 1 and the axle 2 are arranged in a mold set which is not shown, a non-conductive material 3 is filled in the enlarged partition of the passage 12 to connect the axle 2 and the casing 1. The non-conductive material 3 also forms a sheath to mount on a section of the axle 2 beyond the first end of the casing 1.

The manufacturing processes are simplified and only the casing 1 and the axle 2 are needed to be fabricated. The stocking and management for the casing 1 and the axle 2 are easy when compared to the conventional terminals. There are only three steps needed for the terminal of the present invention, the first step is to assemble the casing 1 and the axle 2 and put the two parts in a mold set, the second step is to inject the non-conductive material into the mold set, and the third step is to remove the terminal from the mold set. The terminals of the present invention have much better quality and the non-conductive material can be cooled after the being removed from the mold set, the terminals can be proceeded in tests after the terminals are removed from the mold set without drying days needed.

While we have shown and described the embodiment in accordance with the present invention, it should be clear to those skilled in the art that further embodiments may be made without departing from the scope of the present invention.

1. A terminal structure for coaxial cables comprising:
a casing having a flange extending radially outward from a first end thereof, a passage defined axially through the casing and a plurality of stops extending from an inner periphery of the passage;
an axle having a connection end and a plurality of protrusions extending from an outer periphery of the connection end, the connection end of the axle inserted into the passage, and
a non-conductive material filled in a partition of the passage and connecting the axle and the casing.
